(19) United States
(12) Patent Application Publication
(10) Pub. No.: US 2022/0088425 A1
(43) Pub. Date: Mar. 24, 2022

(54) SYSTEMS AND METHODS FOR MONITORING THE CONDITION OF A FALL - PROTECTION SAFETY SYSTEM

(71) Applicant: 3M INNOVATIVE PROPERTIES COMPANY, St. Paul, MN (US)

(72) Inventors: Rick G. Miller, Prescott, WI (US); Andrew K. Thomforde, Goodhue, MN (US)

(21) Appl. No.: 17/425,663

(22) PCT Filed: Feb. 19, 2019
(86) PCT No.: PCT/IB2019/051337

§ 371 Date: Jul. 23, 2021

(51) Int. Cl. A62B 35/00; A62B 35/04; E06C 7/18

(52) U.S. Cl. CPC A62B 35/0075; A62B 35/005; E06C 1/381; A62B 35/04; E06C 7/186; A62B 35/0056

(57) ABSTRACT

Systems and methods for monitoring and reporting the condition of a permanent fall-protection safety system. The systems and methods use a sensor to obtain data corresponding to a physical state of at least one component of the safety system, the at least one component and the sensor being at a remote location and/or at an elevated height, relative to a base unit. The systems and methods further include wirelessly transmitting the data to the base unit, processing the data to reach an indication of a change in a physical state of the at least one component of the safety system, and reporting the condition of the safety system based on the indication of the physical state of the at least one component of the safety system.

### BACKGROUND

Fall-protection systems are often used to enhance human safety when persons are working at elevated heights or are otherwise at risk of falling.

### SUMMARY

In broad summary, herein are disclosed systems and methods for monitoring and reporting the condition of a permanent fall-protection safety system. Such systems and methods use a sensor to obtain data corresponding to a physical state of at least one component of the safety system, the at least one component and the sensor being at a remote location and/or at an elevated height, relative to a base unit. The systems and methods further comprise wirelessly transmitting the data to the base unit, processing the data to reach an indication of a change in a physical state of the at least one component of the safety system, and reporting the condition of the safety system based on the indication of the change in the physical state of the at least one component of the safety system. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a front-side perspective view of an exemplary fall-protection safety system provided with a monitoring system comprising a sensor and a base unit, for monitoring and reporting the condition of the safety system.

FIG. 2 is a block diagram, in generic representation, of a sensor that can be used in monitoring the condition of a safety system.

FIG. 3 is a side view of an upper end, and an exemplary top bracket, of a fall-protection safety system of the general type shown in FIG. 1.

FIG. 4 is a top view of another exemplary fall-protection safety system that can be provided with a monitoring system for monitoring and reporting the condition of the safety system.

FIG. 5 is a perspective view of an exemplary anchor of a fall-protection system of the general type shown in FIG. 4.

FIG. 6 is a side view, in partial cutaway, of an exemplary anchor of the general type shown in FIG. 5.

FIG. 7 is a side view, in idealized representation, of an exemplary anchor of the general type shown in FIGS. 4 and 5, having been deployed.

FIG. 8 is a top view of another exemplary fall-protection safety system, provided with a monitoring system for monitoring and reporting the condition of the safety system.

FIG. 9 is a side view in partial cutaway, of an exemplary in-line energy absorber of the general type shown in FIG. 8.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated. Although terms such as “first” and “second” may be used in this disclosure, it should be understood that those terms are used in their relative sense only unless otherwise noted.

Terms such as vertical, upward and downward, above, and below, and so on, have their ordinary meaning with respect to the Earth's gravity. The vertical axis (Av) is indicated in several Figures. The horizontal direction likewise has its ordinary meaning as any direction perpendicular to the vertical direction.

As used herein as a modifier to a property or attribute, the term “generally”, unless otherwise specifically defined, means that the property or attribute would be readily recognizable by a person of ordinary skill but without requiring a high degree of approximation (e.g., within +/−20% for quantifiable properties). For angular orientations, the term “generally” means within clockwise or counterclockwise 15 degrees. The term “substantially”, unless otherwise specifically defined, means to a high degree of approximation (e.g., within +/−10% for quantifiable properties). For angular orientations, the term “substantially” means within clockwise or counterclockwise 5 degrees. The term “essentially” means to a very high degree of approximation (e.g., within plus or minus 2% for quantifiable properties; within plus or minus 2 degrees for angular orientations); it will be understood that the phrase “at least essentially” subsumes the specific case of an “exact” match. However, even an “exact” match, or any other characterization using terms such as e.g. same, equal, identical, uniform, constant, and the like, will be understood to be within the usual tolerances or measuring error applicable to the particular circumstance rather than requiring absolute precision or a perfect match. The term “configured to” and like terms is at least as restrictive as the term “adapted to”, and requires actual design intention to perform the specified function rather than mere physical capability of performing such a function. All references herein to numerical parameters (dimensions, ratios, and so on) are understood to be calculable (unless otherwise noted) by the use of average values derived from a number of measurements of the parameter.

### DETAILED DESCRIPTION

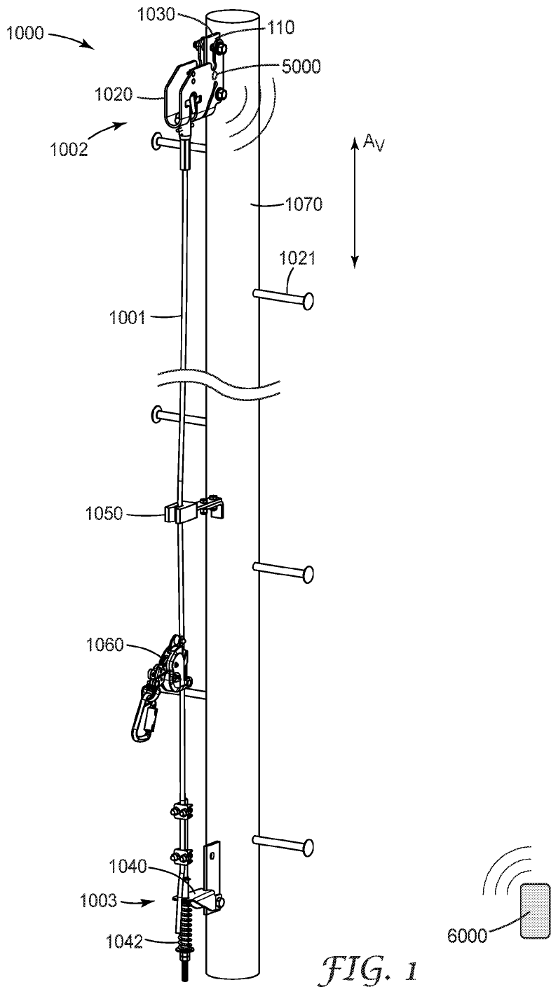

Disclosed herein are systems and methods for monitoring and reporting the condition of a permanent fall-protection safety system. An exemplary permanent fall-protection safety system 1 with which such systems and methods can be used in is shown in generic representation in FIG. 1. By a permanent safety system is meant one that is installed in a specific location for at least four weeks (up to, in some instances, years). By definition, a permanent system will include at least one permanent, elongate member (e.g. a cable or a rail) that is fixed in place on a structure (e.g. a building, tower and so on) for the duration of the use of the system, and that allows a person to move along at least a portion of the elongate length of the member while remaining connected to the member e.g. by a tether as described in detail later herein. By fixed in place is meant that at least at both ends of the elongate member (and in some instances, one or more intermediate locations between the ends of the member) are fixed in place (e.g. by way of brackets, anchors, or the like) at specific, unchanging locations on the structure.

In some embodiments, the permanent, elongate member may be made of metal (e.g. galvanized steel, stainless steel, or the like). In other embodiments, the permanent, elongate member may comprise synthetic organic polymeric materials (e.g. polyesters, aromatic amides such as e.g. KEVLAR, ultra-high molecular weight polyethylene fibers such as e.g. DYNEEMA and SPECTRA, and so on). In some embodiments the permanent, elongate member may comprise carbon fibers, e.g. the member may comprise carbon-fiber-reinforced plastic. In some embodiments the permanent, elongate member may take the form of a cable comprised of twisted fibers, yarns, plies or the like; in other embodiments the permanent, elongate member may comprise e.g. a molded or extruded rail. In embodiments in which the permanent, elongate member is a cable, by definition such a cable will be a tensioned cable as defined and described below.

As can be appreciated from the above discussions, in some embodiments a permanent safety system as disclosed herein will not rely on a fixed-in-place elongate member that is an organic polymeric rope or line (instead, the member may be e.g. a metal cable or rail). However, it will be understood that a permanent system as disclosed herein may often be used in combination with a non-metallic (e.g. organic polymeric) tether that connects the harness of a user to a “traveler” that is slidably movable along a fixed-in-place, elongate member of the permanent system. It will also be understood that a permanent safety system as disclosed herein does not encompass a system or apparatus such as e.g. a so-called self-retracting lifeline (SRL) that is connected to a structure only at one end of the SRL. However, it will be further understood that in some specific embodiments an SRL can be used in combination with the herein-disclosed permanent safety system.

In some embodiments, such a permanent, fixed-in-place fall-protection safety system will comprise an elongate member that is a tensioned cable (e.g., a tensioned metal cable of nominal 8 mm diameter). By a tensioned cable is meant a cable that is permanently maintained at a tension of at least 0.2 kN. In various embodiments, a cable of a fall-protection safety system may be tensioned to at least 0.3, 0.5, 0.8, 1.0, 1.5, 2.0, 2.2, 2.5, 3.0, 4.0, 5.0, or 5.5 kN. In further embodiments, such a cable can be tensioned to at most 10, 6.0, 5.5, 4.5, 3.5, 2.3, 2.1, 1.7, 1.2, 1.1, 0.9, or 0.7 kN. (These ranges can apply to both vertical safety systems and horizontal safety systems.)

In some embodiments, a fall-protection safety system as disclosed herein may act to arrest a fall of a user of the system in the event that a fall occurs. In other embodiments, such a fall-protection system may act to ensure that a user is not subject to a fall, e.g. does not come close enough to an edge of a rooftop to fall. In various embodiments, a fall-protection safety system may be a vertical system that protects a user that is e.g. climbing a ladder or similar structure, or a horizontal system that protects a user that is e.g. moving about a rooftop or similar structure. Such safety systems are often referred to respectively as vertical lifelines (VLLs) and horizontal lifelines (HLLs). (In the industry vernacular, the actual elongate member (e.g. tensioned cable) of such a safety system is occasionally referred to as a “lifeline”.) Vertical lifelines and horizontal lifelines are discussed in detail later herein. The systems and methods disclosed herein use at least one sensor 5000 to obtain data corresponding to a physical state of at least one component of the safety system and to wirelessly transmit the data to a base unit 6000, as shown in generic, exemplary embodiment in FIG. 1. (Such systems and methods may be collectively referred to for convenience herein as a “monitoring system”.) By definition, the sensor, and the component that the sensor monitors, are at a remote location and/or at an elevated height, relative to the base unit. By a remote location is meant that the sensor and the monitored component are at least 5 meters away (along any direction, vertical or horizontal or a combination thereof) from a base unit to which the sensor transmits data (directly or indirectly). By an elevated height is meant that the sensor and the monitored component are at least 5 meters vertically above the base unit.

It will be appreciated that the systems and methods disclosed herein advantageously allow the condition of a permanent safety system to be monitored and reported without the necessity of a person physically traveling (e.g. climbing) to the actual location of a particular component of the safety system.

The systems and methods disclosed herein use one or more sensors that are stationary, permanent, and self-powered (i.e. by a battery). By stationary and permanent is meant that the sensor is mounted (whether on a component of the safety system or on a portion (e.g. a wall, floor, roof, etc.) of a structure that the safety system is installed on) in a specific, unchanging location during the use of the safety system, although the sensor may of course be replaced if necessary. Such arrangements thus are distinguished, for example, from the use of an unmanned aerial vehicle (a UAV or drone) to inspect a safety system. Nor do such arrangements encompass e.g. the use of a ground-based, long-range camera that is positioned e.g. more than 100 meters away from the safety-system component that is monitored. It will be clear from the detailed discussions later herein that a sensor need not be mounted directly on a particular component that the sensor is to monitor, although this can be done in certain embodiments.

A sensor as used herein monitors the physical state of at least one component of a safety system. In various embodiments, such a physical state may be a location (whether absolute or in relation to another component of the safety system), an orientation (e.g. an angle relative to an initial axis, e.g. a vertical axis, of the component), a geometric shape of the component, or any combination of these. Thus in various embodiments such a sensor or sensors may monitor one or more of a displacement from an initial location, a displacement from an initial orientation, a deformation from an initial geometric shape, and so on. Such occurrences will be referred to herein by the general term “deflection”. In some instances, such deflection may be relatively small (e.g. only a few mm in distance or a few degrees in angular orientation) or may be relatively large (e.g. a component may deflect to the point of bending sharply or even folding, collapsing or breaking). Regardless of the particular physical state that is monitored, the monitoring does not encompass e.g. monitoring of the chemical state (e.g. composition, oxidation state, and so on) of the component.

In some particular embodiments, the component of the safety system whose deflection is to be monitored may be a component that is purposefully configured to deflect under particular circumstances in the use of the safety system. Examples of this are discussed in detail later herein. In general, some such components may be configured so as to deflect a small amount (e.g. within the elastic limit of the material of which the component is made) upon exposure to a small force, and to deflect a large amount if and when a very large force (e.g., above the elastic limit of the material) is encountered.

It will be appreciated that the systems and methods disclosed herein are configured to allow the condition of the fall-protection safety system to be monitored, e.g. so that it can be determined e.g. whether a deflectable component of the safety system has deflected to such an extent that the component should be checked and/or replaced prior to further use of the safety system. Such arrangements are distinguished from arrangements that merely report e.g. that a fall event (of a user of the safety system) has occurred or is occurring. In fact, in some instances a change in the physical state of a component of a safety system as monitored and reported by the arrangements disclosed herein, may not be the result of a fall event. Rather, such a change might be the result of factors such as high winds, hail, debris impact, and so on. Some such changes might even result from the effect of differential sun/shade (in which some areas of a structure are in bright sunlight while others are in shade) on various portions of tall structures such as towers, windmills or the like. In some cases the thermal effect of such phenomena may be enough to cause warping, bending, twisting or the like, of the topmost portion of the structure (such effects are charmingly referred to in the trade as “sunflowering”). Such motion may potentially affect one or more components of a safety system installed on such a structure.

From these discussions it is clear that the systems and methods disclosed herein go far beyond the monitoring or detection of fall events. Rather, these systems and methods are configured to report changes in the physical condition of a fall-protection system rather than to report that a fall event may have occurred. It will also be apparent that even if a sensor is primarily configured to monitor e.g. a particular, deflectable component of a safety system, in some embodiments the presence of the sensor may also allow monitoring of other components of the system, so that the general condition of the system, environmental damage to other components of the system (e.g. from a debris impact), and so on, can be detected.

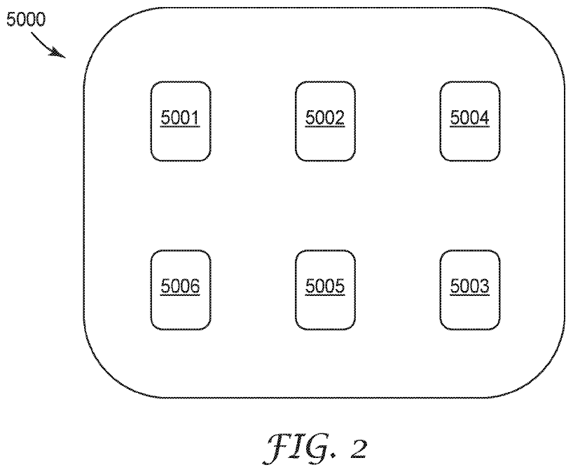

As used herein, the term sensor broadly encompasses any device 5000 that (as shown in exemplary, generic representation in FIG. 2) comprises at least one sensing element 5001 along with such other components as are needed to facilitate operation of the sensing element and transmission of the data obtained by the sensing element to a base unit. Such a sensor will thus comprise at least one or more sensing elements 5001, a radio transmitter 5002 and an internal power source (a battery) 5003. In various embodiments, such a sensor may additionally comprise any or all of a radio receiver 5004, one or more data-storage units 5006, and/or one or more data-processing units 5005. In some embodiments one or more of these units or functionalities (e.g. a data-processing unit and a data-storage unit) may be combined in a single entity, e.g. an integrated circuit or chip. Still other components or functionalities may be present. For example, the sensor may comprise e.g. a photovoltaic solar cell that can be used to recharge the battery, may comprise other sensing elements for other purposes (e.g. accelerometers, temperature sensors, humidity sensors, and so on), and so on.

In other words, sensor 5000 will comprise whatever hardware and physical components are needed for the desired functioning, along with whatever software, firmware, and so on, that is needed to operate the sensing element to obtain data, to store the data if desired, to transmit the data to a base unit, and so on. Any or all such physical components and such ancillary circuitry, wiring and so on as needed to operate the various hardware components, may conveniently be provided in a housing, e.g. a molded plastic housing, that will protect the components from environmental conditions. In some embodiments, at least a portion of a sensing element 5001 may extend from, or be positioned outward of, such a housing to the extent needed to allow the sensing element to function.

A sensing element 5001 of a sensor 5000 may function according to any mechanism that will allow the sensing element to monitor the physical state of a component (e.g., a deflectable component) of the fall-protection safety system as needed. In some embodiments, such a sensing element may perform optical monitoring e.g. of the position, orientation, and/or shape of at least a portion of the component in question. In some such embodiments, such a sensing element may comprise a camera that obtains an image, multiple images, or a stream of images, in order to perform such functions. Such a sensing element need not necessarily be mounted directly on the component in question, although in some embodiments it can be so mounted. Rather, in various embodiments, such a sensing element (and, e.g. sensor 5000 as a whole) may be mounted on some other component of the safety system, on a member or arm that extends away from some component of the safety system (e.g. in the general manner of a selfie stick), or on a portion (e.g. a wall) of a structure on which the safety system is installed.

In some embodiments, such a sensing element may comprise a strain gauge. In some embodiments of this type, such a sensing element may directly measure the strain in a specific location of a component (e.g. an area of a deflectable component in which any actual deflection or deformation, if it occurs, will be primarily located). The resulting data may thus provide a direct representation of to what extent the deflection has occurred. Or, in other embodiments, such a sensing element may measure the strain in some other, e.g. non-deflectable, component (e.g., in a tensioned cable) of the safety system. The resulting data may be used to infer (e.g. in calculations performed in the base unit) that a deflection of a deflectable component to a given extent has occurred. Such arrangements are discussed in further detail in regard to particular safety systems, later herein.

Beyond the exemplary sensing elements and operating mechanisms presented above, a non-limiting list of general categories, specific types, and/or and operating mechanisms that may be potentially useful include e.g. position sensing elements, displacement sensing elements, proximity sensing elements, linear position sensing elements, angular position sensing elements, linear or rotary encoders, capacitive displacement sensing elements, Hall effect sensing elements, inductive sensing elements, magnetic sensing elements, optical sensing elements (e.g. cameras, fiber optic sensing elements, etc.), potentiometers, piezoelectric transducers, and so on. Some such sensing elements may be configured and positioned so as to be able to monitor a change in a physical state of a component of a safety system only at the actual time that the change occurs (e.g. with the information being datalogged for later use). Other sensing elements may be configured and positioned so as to be able to monitor that a change in a physical state of a component of a safety system has occurred. Some types of sensing elements may be configured and positioned to be able to perform both functions. Some types of sensing elements may only be able to provide binary data; that is, data indicating whether or not a particular threshold (of, e.g., displacement) has been exceeded. Other types may be able to provide data in a more fine-scale or even continuous format.

In some embodiments, sensor 5000 and sensing element 5001 thereof may be configured to obtain data continuously. In other embodiments these components may be configured to obtain data quasi-continuously, meaning that data is obtained at least every 0.2 seconds. In various embodiments data may be obtained intermittently, e.g. at a frequency of less than five times per second; or, less than once every 10 seconds, per minute, per hour, or per day. In particular embodiments, sensor 5000 may operate on-demand and will not obtain data until directed to by a wireless signal from a base unit.

Thus in various embodiments, sensor 5000 may operate continuously, quasi-continuously, intermittently, or on-demand. If the interval between data-taking is long enough, sensor 5000 may enter a dormant mode in between data-taking. During such intervals, in some embodiments only an internal clock may be operating that triggers sensor 5000 to instruct sensing element 5001 to obtain data at a particular time. In some embodiments, sensor 5000 may enter a dormant mode e.g. in which the only operation performed is listening (electronically) for a wireless signal from a base unit, which signal will trigger sensor 5000 to awaken to transmit data to the base unit, to take new data, and so on. It will be appreciated that various such arrangements may enhance the life of internal power source (battery) 5003.

In some embodiments, data taken by sensing element 5001 may be stored on-board sensor 5000, e.g. in data storage unit 5006. The data may be stored in this manner until transmitted to a base unit, after which (and e.g. after confirmation from the base unit that the data was successfully received) the data may be erased from the storage unit. In particular, measurements such as strain may be measured at least quasi-continuously and may be datalogged in the data storage unit until such time as it is transmitted to the base unit.

Although some uses of the herein-disclosed monitoring systems may be indoors, many uses of such systems may be outdoors and exposed to the elements to varying degrees. Many such uses (e.g. at the top of a tower or other unshielded outdoor structure) will involve a harsh environment. Thus, to serve in such applications any such sensor, sensing element, and other components thereof, would have to be able to survive prolonged exposure to, for example, temperature extremes, sunlight, rain, snow, sleet, hail, wind, storms, and so on. The sensor would also need to have an appropriate battery life.

As shown in exemplary, generic representation in FIG. 1, the data that is obtained by sensor 5000 is wirelessly transmitted to a base unit 6000. In some embodiments such a base unit is portable, e.g. a smartphone, a tablet computer or a laptop computer, a dedicated (single-purpose) electronic device, or the like. In some such embodiments, sensor 5000 may be configured to transmit (e.g. by way of radio transmitter 5002) a short-range wireless signal directly to the base unit. Thus for example, a user of a safety system (or a designated person such as an on-site environmental health and safety (EHS) manager) may carry a portable base unit (e.g. a smartphone) close enough to the sensor that the sensor is able to wirelessly transmit a signal directly to the smartphone via e.g. Bluetooth, ZigBee, wi-fi, or any desired short-range method.

In some embodiments, the sensor may comprise a radio receiver 5004 that can receive wireless signals at least from the base unit 6000. Such a receiver can allow two-way communication to occur, e.g. so that the sensor and base unit can perform identification, an electronic handshake, and so on, e.g. to ensure that the base unit is in communication with the proper sensor and vice versa. In some such embodiments, the sensor can receive a signal from the base unit that instructs the sensor to transmit whatever data is currently in storage on-board the sensor. In some particular embodiments, the base unit can send a signal to the sensor to obtain data and to transmit the data to the base unit (with or without the data being stored on-board the sensor prior to being transmitted). In some embodiments, a base unit 6000 may be equipped with geofencing capability, and the safety system and sensor can be within a geofenced area as designated in the base unit's geofencing program. In such embodiments, entering the geofenced area around the safety system (which geofenced area may be designated as having any desired radius, e.g. 100 meters), the base unit can be triggered to automatically contact the sensor rather than a user of the base unit having to direct the base unit to do this.

In some embodiments, data may be sent to the base unit without having been stored on-board the sensor. For example, a sensing element 5001 of sensor 5000 may comprise a camera (alone, or along with other sensing elements operating by different mechanisms). In some such embodiments, the camera may be instructed by the base unit to obtain a still image, or a series of still images, and to transmit the image or images to the base unit without storing them on-board the sensor. Or, the camera may be instructed by the base unit to obtain a video stream and to transmit the streaming video to the base unit without storing the images on the sensor. Many variations on this are possible. Of course, in other embodiments any such data may be stored on-board the sensor before being transmitted to the base unit.

It will be appreciated that any or all such functionality may conveniently be provided e.g. in the form of an application (“app”) that is resident on the base unit, e.g. a smartphone. In some instances (e.g. if the app is geofencing-enabled), the app may perform at least some of the functions described herein while in a background state rather than having to be launched onto the foreground screen of the smartphone in order to function.

In some embodiments, a base unit 6000 may be fixed (non-portable), e.g. a desktop computer, mainframe or server. In some embodiments such a fixed base unit may be located e.g. at a central office or monitoring station and may be configured to concurrently receive data from multiple sensors of multiple safety systems. Such a base unit may thus be configured to receive data corresponding to a physical state of at least one component of a safety system to which a permanent lifeline is connected, from a plurality of sensors of different safety systems.

In some embodiments (regardless of whether the base unit is fixed or portable) the data can be transmitted along a portion of its path through cellular towers and/or through electrical wires or fiber optical cables. For example, a wireless signal from a sensor 5000 may be received by an intermediate unit, which intermediate unit then forwards the signal to the base unit through a cellular network and/or through electrical wiring and/or fiber optical cables. It will thus be understood that “wireless” transmission and like terminology, requires only that at least a portion of the total signal path from the sensor to the base unit (i.e. an initial portion originating from the sensor) must be wireless.

In some embodiments, a plurality of fall-protection safety systems may be present and may be subjected to monitoring as disclosed herein. This might occur, for example, in an oil refinery comprising numerous distillation towers and the like. In some instances, such safety systems (and sensors thereon) may be located over a wide area, e.g. of several square miles. In such situations, it may be useful that at least some of the sensors are configured so that in addition to transmitting their own data to a base unit, the designated sensors can also act as relays or repeaters that can receive data from other sensors and can pass along that data to the base unit. Thus in some embodiments, a first sensor of a first safety system may be configured to transmit data obtained by the first sensor and to include information identifying the data as originating from the first sensor; and, may be further configured to wirelessly receive data from a second sensor of a second safety system and to re-transmit the data from the second sensor along with information identifying the data as originating from the second sensor. Such arrangements may be repeated for any desired number of sensors.

The data received by the base unit can be processed as desired to reach an indication of the physical state of the at least one component of the safety system. This processing can take any suitable form depending e.g. on the nature of the data as transmitted by the sensor. In some particular embodiments, the raw data obtained by the sensing element 5001 of the sensor 5000 may be processed on board sensor 5000 (e.g. by suitable circuitry 5005). In such cases, the base unit may merely receive a signal that is directly indicative of the state of the component in question and may need to perform little or no further processing of the data other than to issue a status report on the condition of the safety system. In other instances, the base unit may receive data that requires considerable processing in order to reach an indication of the state of the component in question and thus to issue a status report on the condition of the safety system. Such data may, for example, take the form of strain measurements obtained from a sensing element 5001 of sensor 5000. Such data may, for example, need to be converted to expected values of deflection of a deflectable component of the safety system, as discussed in further detail later herein. It will be understood that a wide variety of data forms and commensurate processing steps to be performed by the base unit, are possible.

Regardless of the nature and extent of the processing that is performed by the base unit, the result will be an indication of the physical state (in particular, any change in the physical state) of the at least one component of the safety system. This information will be used to report the condition of the safety system. Such a report may be e.g. that the safety system has no known issues (although such a report will not necessarily indicate that the safety system can be used without all required inspections being performed, and so on). Or, such a report may be that a deflectable component of the safety system may have been deflected (whether temporarily or permanently) above a threshold value and may need to be inspected to determine e.g. whether it should e.g. be replaced.

In some instances, the reporting of the condition of the safety system may only occur upon a request by a user as inputted through base unit 6000, or according to some predetermined schedule. In some embodiments, if data indicates a particular physical state of a component of the safety system, the base unit may push a report to a user rather than e.g. waiting for the user to enter a query or waiting according to a schedule. For example, if data is received indicating that the safety system may need to be inspected, a push signal may be issued by the base unit.

The reporting of the condition of the safety system can take any suitable form, e.g. a signal, text, email, alarm, or, in general, a signal of any form, on a portable base unit such as a smartphone. Such a signal may be visual and/or audible. Or, any such signal can e.g. appear on a screen of a fixed base unit such as a desk-top computer. Multiple signals of different types can be sent to different base units, as desired.

The monitoring systems and methods disclosed herein may be used with any permanent fall-protection safety system. In some embodiments, such a safety system may be a “vertical” system (such systems are often referred to as vertical lifelines). A vertical fall-protection safety system is defined herein as a system that allows a person to undergo an elevation change along an at least generally vertical path (i.e., within 15 degrees of vertical), although the person may not necessarily change elevation significantly during every use of the safety system. In various embodiments an elongate member (e.g. a rail or tensioned cable) of such a safety system may be oriented within 15, 10, 5, or 2 degrees of vertical.

Such safety systems may be used e.g. when a person is ascending, descending, or otherwise using a climbing apparatus (e.g. a ladder) in the course of constructing, servicing, inspecting, or, in general, working with or around structures that exhibit a relatively large and/or steep elevation change. Examples of such structures include buildings, telecommunication towers, utility poles, water towers, distillation towers, smokestacks, silos, wind turbines, oil rigs, cranes, mine shafts, air shafts, cargo holds, grain bins, and so on. Exemplary vertical fall-protection safety systems include the products available from 3M Fall Protection, Red Wing, Minn., under the trade designation 3M DBI-SALA LAD-SAF. In some embodiments, a vertical fall-protection safety system may meet the requirements of ANSI Z359.16-2016 (Safety Requirements for Climbing Ladder Fall Arrest Systems), as specified in 2016. In particular embodiments, such a safety system may meet the requirements of Section 4.2.1 (Dynamic Performance) and Section 4.2.2.4 (Static Strength) of this standard. In some embodiments, such a safety system may meet the requirements of OHSA rule 1926.1053, Section (a)(22)(i) (Dynamic Strength).

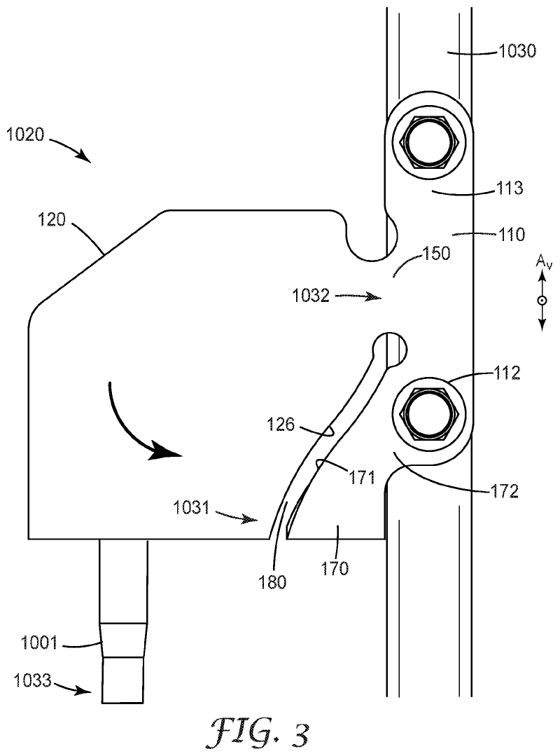

A vertical fall-protection safety system 1000 is depicted in exemplary representation in FIG. 1. Safety system 1000 comprises an elongate member (in this embodiment, a tensioned cable, made of e.g. metal such as galvanized steel or stainless steel) 1001, an upper end 1002 of which is connected to a top bracket 1020 and a lower end 1003 of which is connected to a bottom bracket 1040. Top bracket 1020 can be attached to a structure (e.g., a building, tower, pole, and so on) e.g. by way of a rail 1030 (as seen in more detail in FIG. 3); bottom bracket 1040 can be similarly attached. Depending on the length of cable 1001, one or more intermediate brackets 1050 may be provided. A tensioning unit 1042 can be provided to enable cable 1001 to be tensioned appropriately, e.g. in accordance with any of the ranges listed previously.

System 1000 provides fall protection for a person that is climbing, descending, or is stationary, on a “ladder” that is collectively provided by rungs 1021 that are attached or otherwise connected to an at least generally vertical structure or an at least generally vertical portion of a structure. (In the depicted embodiment of FIG. 1, the structure is a monopole 1070.) To achieve this, the person wears a harness to which is attached one end of a tether or lanyard, the other end of which is attached to traveler 1060. Traveler 1060 (sometimes referred to as a cable sleeve, glider or grab) is able to move (e.g. slide) along cable 1001, so that the person can ascend or descend structure 1070 as desired. Typically, a traveler 1060 will be configured so that if sudden motion in a particular direction (e.g. downward) is encountered, the traveler will automatically brake to arrest a fall of the person using the traveler. The traveler and/or a tether that connects the user's harness to the traveler may comprise a shock absorber. All such details and functions of vertical lifelines and components thereof will be readily understood by artisans in the field.

As disclosed herein, one or more sensors can be used to obtain data corresponding to a physical state of at least one component of a vertical fall-protection safety system. In some embodiments involving a vertical safety system, the component that is monitored may be a top bracket of the safety system. Such arrangements encompass e.g. the monitoring of a top bracket in its entirety, as well as the monitoring of one or more specific components of a top bracket, as discussed below.

In some embodiments a vertical safety system that is monitored according to the systems and methods disclosed herein may comprise a component that is purposefully designed to be deflectable in particular circumstances, e.g. upon the application of a force above a certain threshold. FIG. 3 (which is an isolated, magnified view of the upper end of exemplary vertical safety system 1000 of FIG. 1) shows an exemplary arrangement of this type. In the depicted embodiment, the top bracket 1020 comprises a base 110 with upper and lower portions 113 and 112 and that is attached to a rail 1030 or other suitable item that is a part of, or is attached to, a structure, as noted above.

Top bracket 1020 as pictured in FIG. 3 comprises at least one pivotally deflectable component (e.g. one or more plates) 120 that is pivotally connected to base 110 by a neck 150. In many convenient embodiments base 110 and one or more pivotally deflectable plates 120 may be portions of a single, unitary, integral structure. Plate 120 will typically be cantilevered (i.e. unsupported at its forward end that is opposite neck 150), as shown in FIG. 3. The base, plate and neck are configured so that a downward force (e.g. as transmitted through cable 1001 to plate(s) 120) above a predetermined threshold will cause plate(s) 120 to pivotally deflect downward relative to base 110.

By pivotally deflectable is meant that plate 120 can move at least generally downwardly and rearwardly (as indicated by the curved arrow in FIG. 3) about an axis of pivotal deflection that passes at least generally through neck 150. Such arrangements can provide that a downward force transmitted by cable 1001 to plate 120 (e.g. in the event of a worker fall) can cause plate 120 to pivotally deflect slightly downward and rearward into a deflected configuration. This can at least somewhat attenuate any force that is transmitted through top bracket 1020 to a rail 1030 and thus to an item or structure to which the rail is attached. Such an arrangement can advantageously reduce any damage or wear to the rail, item or structure.

Deflectable plate 120 (e.g. neck 150 thereof) can be configured so that a force that is below a chosen threshold does not cause the material of neck 150 to be stressed beyond its elastic limit. In other words, in such instances the stress experienced by the material of neck 150 will remain below an amount that could cause permanent deformation of the material. This can provide that essentially no permanent (e.g. plastic) deformation of neck 150, or of any portion of deflectable plate 120 or top bracket 1020 as a whole, occurs upon top bracket 1020 encountering a force that is below the chosen threshold. Top bracket 1020 will thus return to its original condition (i.e. with plate 120 in a non-deflected configuration) after the downward force is removed. Thus, top bracket 1020 may be able to undergo a number of events such as e.g. a worker fall-arrest below a certain force threshold, as well as momentary tugs and the like as may occur during normal work operations, without being affected (e.g. undergoing permanent deformation) to the point that top bracket 1020 necessarily needs replacing. Such events will not result in a change in a physical state of a component of the safety system that is reported according to the systems and methods disclosed herein.

However, if a force is encountered that is above the chosen threshold, the pivotal deflection of plate 120 may cause the material of neck 150 to exceed its elastic limit, thus causing some (e.g. small) amount of permanent deformation. This may cause plate 120 to remain in its deflected configuration, or at least to not return fully to its original undeflected configuration, after the force is removed. In consideration of this, in some embodiments top bracket 1020 may comprise an abutment plate 170 that extends generally forwardly from a lower portion 112 of base 110, so that at least a portion of abutment plate 170 is positioned generally under, and/or generally rearward of, at least a portion of pivotally deflectable plate 120. (In FIG. 3, the junction of abutment plate 170 with base 110 is indicated in general as location 172). Abutment plate 170 and pivotally deflectable plate 120 may be configured so that a gap 180 is present between a rearward edge 126 of plate 120 and a forward edge 171 of abutment plate 170. Any change (e.g. downward-rearward deflection) in the position of plate 120 may thus be manifested as a change (i.e. a narrowing) in the width of gap 180. Furthermore, abutment plate 170 may serve to bear some of the load if a force is encountered that is large enough to deflect plate 120 so that its rearward edge 126 contacts forward edge 171 of abutment plate 170.

Vertical fall-protection safety systems of this general type are described in further detail in U.S. Provisional Patent Application No. 62/607,409, entitled Top Bracket for Fall Protection Safety System, and in the resulting International (PCT) Application No. PCT/US2018/066180, both of which are incorporated by reference in their entirety herein.

Any suitable sensor, operating by any desired mechanism and placed at any suitable location, may be used to monitor a vertical fall-protection safety system (vertical lifeline) e.g. of the general type represented in FIG. 1. In some embodiments, such a sensor might rely on a sensing element in the form of a strain gauge. Any suitable strain gauge may be used, e.g. comprising a grid of wire filaments and bonded e.g. by epoxy to a surface of the component to be monitored (sometimes referred to as a bonded-foil strain gauge). Such a strain gauge might be located at any suitable position. For example, it might be located at or near position 1032 as shown in FIG. 3; that is, at the location (neck 150) that is likely to experience the greatest force. Since at this particular location the force may be at least partly rotational and/or multi-directional, a so-called strain gauge rosette comprising multiple strain gauges oriented in different directions, operating in combination, may be used. Such an approach may allow the deformation (whether temporary or permanent) experienced by neck 150 to be ascertained.

In some embodiments a strain gauge may be located at or near position 1033 as shown in FIG. 3; that is, at an upper end of cable 1001. In such cases the strain that is detected in cable 1001 may be correlated with the force expected to produce such a strain. This force may then be correlated with the expected force experienced by top bracket 1020 and specifically neck 150 thereof, and/or with the expected deflection of pivotally deflectable plate 120. In other words, the strain experienced by cable 1001 can be used to infer whether top bracket 1020 has experienced a large enough force to cause a change in the physical state of the top bracket.

It will be appreciated that permanent deflection (e.g. stretching) of cable 1001 may not necessarily occur even in the event of a permanent deflection of e.g. a pivotally-deflectable plate 120. Accordingly, a strain gauge mounted on cable 1001 is an example of an arrangement in which a sensing element may need to be operated at least quasi-continuously or continuously in order to ensure that, for example, a strain event of large magnitude but short duration will be detected and datalogged. However, as discussed in detail below, in other arrangements (e.g. not involving monitoring of the strain present in a tensioned cable) it may not be necessary for a sensing element to be operated even quasi-continuously, since in many such arrangements it may be possible to detect the consequences of an event (e.g. permanent deformation of a component of the top bracket) after the fact.

In some embodiments a strain gauge may be located at or near position 1031 as shown in FIG. 3, at which position the gauge may be able to detect a change (whether temporary or permanent) in the width of gap 180 between respective edge surfaces 126 and 171 of pivotably deflectable plate 120 and abutment plate 170. The use of a strain gauge for purposes of monitoring gap 180, is only a particular subset of the general approach of monitoring gap 180 by any suitable sensing element, operating by any suitable mechanism. That is, gap 180 provides a useful parameter by which any deflection (whether temporary or permanent) of deflectable plate 120 can be monitored. Various sensing schemes and mechanisms may be able to detect temporary deflection and/or permanent deflection, as will be appreciated.

For example, in some embodiments a sensing element might comprise a set of electrical contacts, one (or more) on surface 126 and one (or more) on surface 171. Bringing these into contact with each other can close an electrical circuit thus providing a clear indication that gap 180 has closed to a particular extent. The gap between the contacts (e.g., as established by the distance to which the face of each contact resides outward from its respective surface) can be set so that a deflection of plate 120 to a particular extent will trigger the sensing element to report a deflection event.

Such an arrangement may only provide a binary (yes/no) indication of deflection, relative to a particular threshold. In other embodiments, other types of sensors may be used that can monitor any degree of deflection, whether incrementally or continuously. For example, gap 180 may be optically monitored, e.g. by one or more sensing elements in the form of image acquisition devices (e.g. cameras) positioned to view gap 180. Such a sensing element may be positioned e.g. on an arm extending from any portion of top bracket 1020, may be positioned on (or on an arm extending from) any portion of a structure on which top bracket 1020 is mounted, and so on. Such a sensing element can provide a view of gap 180 (e.g. a view along the lateral axis of the top bracket, as in FIG. 3) that can facilitate the desired monitoring. In some instances it may be advantageous for the sensing element to focus on the portion of gap 180 that is farthest from neck 150, since in many designs the absolute amount of motion (e.g., of narrowing of the gap) may be highest at this location. If desired, pivotally deflectable plate 120 and/or abutment plate 170 may be provided with indicia (whether by e.g. printing, etching, engraving, or the like) that establish a reference distance to which the width of gap 180 can be compared. In some embodiments, rather than monitoring the absolute width of gap 180 in a particular location or locations, an angle between a portion or portions of edge 126 of pivotally deflectable plate 120, and a portion or portions of edge 171 of abutment plate 170, can be monitored. For example, two such portions may be locally parallel to each other when the plates are in an initial condition, and the sensing element can be configured to detect any subsequent deviation from this condition.

In some embodiments, an insert, e.g. a deflectable and/or breakable insert may be positioned within gap 180. Such an insert may be configured e.g. so that a change the gap width that is commensurate with a permanent deflection of plate 120 will deform (e.g. break) the insert. Such an insert may be configured so that any such deformation in the insert will be readily evident to a sensing element (e.g. a camera) that is used to monitor the insert; or, the insert can be configured so that the deformation causes the insert to fall out of the gap, whereupon the insert's absence can be readily detected. Such an approach may provide a binary indication of deflection, relative to a particular threshold. However, if desired multiple inserts, e.g. configured to be deformed at different amounts of deflection of plate 120, can be used.

In various embodiments, a sensing element in the form of an image acquisition device such as a camera may be configured to take single images, whether upon instruction from base unit 6000, or on an intermittent schedule. In other words, such a sensing element may be configured to detect permanent deformation after a strain/deformation event has happened. Such an arrangement may be contrasted e.g. with the use of a strain gauge positioned e.g. on the cable of the safety system that may need to be operated at least quasi-continuously in order that a strain/deformation event can be detected as it happens. Of course, in some embodiments a camera may be configured to provide a continuous video stream, again whether upon instruction, on a schedule, or constantly. While a primary purpose of such a camera may be the monitoring of a deflectable component as discussed herein, a sensing element of this type can also be used to monitor the overall state of a top bracket and/or a structure to which the top bracket is attached, and so on. For example, such a camera may be able to ascertain whether a top bracket or other component of a safety system appears to have sustained damage e.g. from some object (e.g. construction debris) falling onto the safety system. In some embodiments such a camera may be movable, e.g. orientable, so that the camera can examine various items as desired. Multiple cameras may be used if desired.

Not every vertical fall-protection safety system will necessarily comprise a deflectable component in the form of a pivotally-deflectable plate of a top bracket as in the exemplary arrangement described above. Rather, some vertical safety systems may comprise a top bracket that is hard-mounted (i.e. without any component that is purposefully designed to be deflectable). Some such systems may comprise one or more deflectable members in the form of an energy absorber that is mounted in-line with the elongate member (e.g. tensioned cable) of the safety system, in generally similar manner to the in-line energy absorbers discussed later herein with regard to horizontal fall-protection safety systems. In such instances one or more sensing elements (e.g. cameras) may be positioned to monitor any deflection of such an in-line energy absorber. In some embodiments, a vertical safety system may include both an in-line energy absorber and a pivotably deflectable plate; in such instances, one or both such components may be monitored.

Thus in summary, a vertical safety system may be monitored by any suitable sensor, relying on any suitable sensing element operating according to any desired mechanism. In addition to the specific exemplary sensing elements and operating mechanisms discussed above, the previously-presented general categories, specific types, and operation mechanisms of sensing elements, may be chosen for use with a vertical safety system.

In some embodiments, a permanent fall-protection safety system with which the monitoring systems and methods disclosed herein may be used, may be a “horizontal” system (such systems are often referred to as horizontal lifelines). A horizontal fall-protection safety system is defined herein as a system that allows a person to travel along a generally horizontal direction (i.e., within 15 degrees of horizontal). In various embodiments an elongate member (e.g. a rail or tensioned cable) of such a safety system may be oriented within 15, 10, 5, or 2 degrees of horizontal.

Such safety systems may be used e.g. when a person is working on a rooftop or generally similar structure; or, in a larger sense, any generally horizontal area that lacks walls to prevent an edge from being approached. (Such an area might be e.g. a floor of a skyscraper under construction, which floor does not yet have exterior walls installed.) Exemplary horizontal fall-protection safety systems include the products available from 3M Fall Protection, Red Wing, Minn., under the trade designations ROOFSAFE ANCHOR AND CABLE SYSTEM, UNI-8 CABLE SYSTEM, and 8 MM PERMANENT HORIZONTAL LIFELINE. In various embodiments, a horizontal fall-protection safety system may meet the requirements of one or more of EN 795:2012, CENTS 16415:2013, OSHA 1926.502, OSHA 1910.140, and/or ANSI Z359.6 and CSA Z259.16 as specified in 2016.

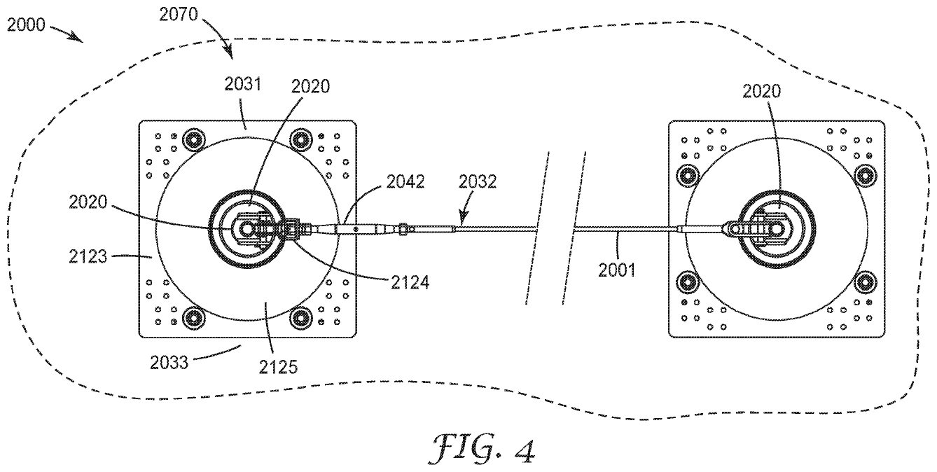

A horizontal fall-protection safety system 2000 is depicted in exemplary representation in the top (overhead) view of FIG. 4. Safety system 2000 comprises an elongate member (in the depicted embodiment, a tensioned cable, made of e.g. metal such as galvanized steel or stainless steel) 2001, one end of which is connected to a first anchor 2020 and a second end of which is connected to a second anchor 2020 (in many instances anchors 2020 may be identical). In the event that system 2000 is relatively long, one or more intermediate anchors (not shown in FIG. 4) may be present between end anchors 2020. Such intermediate anchors may or may not be identical to the end anchors. Any such anchor, regardless of the exact design, is a component that is permanently attached (directly or indirectly) to a particular location of a rooftop, wall or other structure for the duration of the use of the safety system and to which an elongate member (e.g. a tensioned cable) of the horizontal safety system is connected or attached. As shown in the perspective view of an isolated anchor 2020 in FIG. 5, in some embodiments such an anchor may be attached to a baseplate 2123 that can be attached to a roof or other surface 2070 in any desired manner. Anchor 2020 may comprise a connector 2124 (of any suitable type, and optionally comprising multiple components) that facilitates the connection of cable 2001 to anchor 2020. Various components and methods for attaching anchors to roofs or other generally horizontal structures, and various components and methods for connecting elongate members to anchors, are described in detail e.g. in the Engineered Systems Product Catalog published by DBI-Sala (now 3M Fall Protection, Red Wing, Minn.) in 2014. In many embodiments, a horizontal safety system 2000 may comprise a tensioner 2042 to enable a cable 2001 to be tensioned appropriately.

A horizontal fall-protection system of the general type shown in FIG. 4 can provide fall protection for a person working or otherwise present on an at least generally horizontal surface such as e.g. a rooftop. To achieve this, the person wears a harness to which is attached one end of a tether or lanyard, the other end of which is attached to a traveler (not shown in FIG. 4) that is able to move (e.g. slide) along elongate member (e.g., cable) 2001, so that the person can move along the elongate length of member 2001 as desired. Elongate member 2001 does not necessarily have to be straight as in FIG. 4; rather, it can be curved and/or can have one or more corners or relatively sharp direction changes. The traveler and/or a tether that connects the user's harness to the traveler may comprise a shock absorber. All such details and functions of horizontal lifelines and components thereof will be readily understood by artisans in the field.

As disclosed herein, one or more sensors can be used to obtain data corresponding to a physical state of at least one component of a horizontal fall-protection safety system. In some embodiments involving a horizontal safety system, the component that is monitored may be an anchor of the safety system. Such arrangements encompass e.g. the monitoring of an anchor in its entirety, as well as the monitoring of one or more specific components of an anchor, as discussed below.

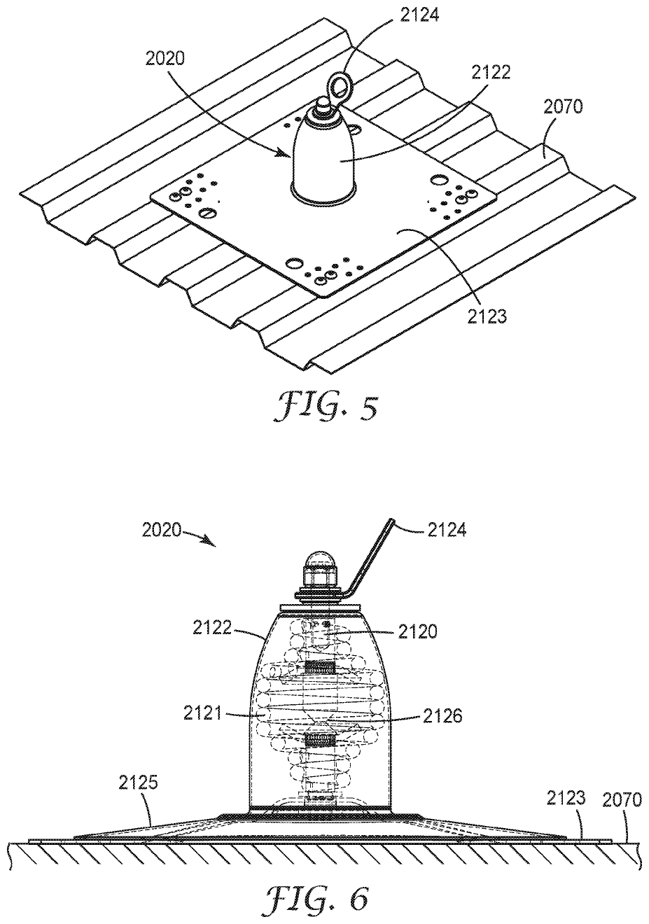

In some embodiments a horizontal safety system that is monitored according to the systems and methods disclosed herein may comprise a component that is purposefully designed to be deflectable in particular circumstances, e.g. upon the application of a force above a certain threshold. FIG. 6 (which is a side cross-sectional view in partial cutaway of an anchor 2020 of the general type shown in FIG. 5) shows an exemplary arrangement of this type. In the depicted embodiment, anchor 2020 comprises a deflectable component (e.g., a member) 2120 that is ordinarily (e.g., in the absence of any significant load applied thereto) positioned with its long axis in an initial orientation. (Typically, this initial orientation is at least generally vertical when the anchor is mounted on a horizontal surface.) Member 2120 may be connected (directly or indirectly) to connector 2124 so that a load that is transmitted to connector 2124 from an elongated member (e.g. a cable) 2001 will be transmitted to member 2120.

Such arrangements can provide that a force transmitted by a cable 2001 to member 2120 (e.g. in the event of a fall of a worker who is connected to cable 2001 by a tether) can cause member 2120 to deflect (e.g., to pivotally deflect) away from its initial configuration into a deflected configuration. This can at least somewhat attenuate any force that is transmitted through anchor 2020 to an item or structure (e.g. a rooftop) to which anchor 2020 is attached. Such an arrangement can advantageously reduce any damage or wear to the item or structure.

Deflectable member 2120 can be configured so that a force that is below a chosen threshold does not cause the material of member 2120 (e.g., in a narrowed neck 2126 thereof as shown in FIG. 6) to be stressed beyond its elastic limit. In other words, in such instances the stress experienced by the material of member 2120 will remain below an amount that could cause permanent deformation of the material. This can provide that essentially no permanent (e.g. plastic) deformation of member 2120 occurs upon member 2120 encountering a force that is below the chosen threshold. Thus, deflectable member 2120 may be able to undergo a number of events such as e.g. worker fall-arrests below a certain force threshold, as well as momentary tugs and the like as may occur during normal work operations, without being affected (e.g. undergoing permanent deformation) to the point that member 2120 and/or anchor 2020 as a whole necessarily need replacing. Such events will not result in a change in a physical state of a component of the safety system that is reported according to the systems and methods disclosed herein.

However, if a force is encountered that is above the chosen threshold, the deflection of member 2120 may result in at least some amount of permanent deformation. This may cause member 2120 to remain in its deflected configuration, or at least to not return fully to its original undeflected configuration, after the force is removed. In fact, in some embodiments member 2120 may be configured to completely break (e.g. at narrowed neck 2126 thereof) in the event that a sufficient force is applied thereto.

In some embodiments, as shown in exemplary embodiment in FIG. 6, an anchor 2020 that comprises a deflectable member 2120 may also comprise a coil spring 2121 (e.g. contained within a shroud 2122) that laterally surrounds at least portions of the deflectable member. The stiffness, deformability, and so on, of such a spring may be configured in combination with the properties of the deflectable member 2120 to provide that the member/spring assembly is able to deflect momentarily and reversibly in response to forces below a certain threshold, but will deflect permanently and non-reversibly, in response to forces above a chosen threshold. In some embodiments coil spring 2121 (or some other body) may be attached to member 2120 at locations above and below neck 2126, so that connector 2124 does not become completely detached from baseplate 2123 and/or rooftop 2070 upon member 2120 breaking at neck 2126. Arrangements in which an anchor comprises a deflectable and/or breakable member along with a suitable coil spring or the like are described in detail in U.S. Pat. No. 9,067,089, which is incorporated by reference in its entirety herein. However, it is noted that not all anchors may comprise such a coil spring; moreover, not all anchors may comprise a deflectable member that is configured to e.g. break completely apart. Anchors of various designs are available from 3M Fall Protection, Red Wing, Minn., under the trade designations ROOFSAFE, SPIRATECH, and SINGLE POINT TIP OVER. In some embodiments, an anchor may comprise an apron 2125 as shown in FIGS. 4, 6, and 7; in other cases, an anchor may not comprise an apron, e.g. as in the arrangement of FIG. 5.

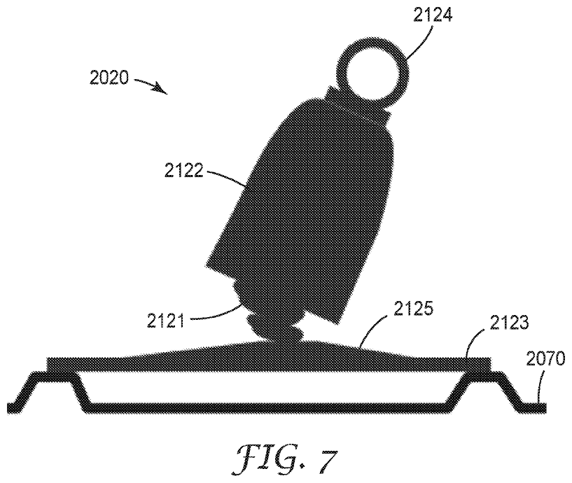

In some embodiments, anchor 2020 may be configured so that permanent deflection, e.g. breaking, of a deflectable member 2120 may result in anchor 2020 (including a coil spring 2121 and a shroud 2122) deflecting as a whole, as shown in exemplary, conceptual representation in FIG. 7. Such an occurrence is sometimes referred to as the anchor having been “deployed”. In some cases, such deflection may take the form of pivoting of the anchor from its initial (e.g. at least generally vertical) orientation, which may result e.g. in a noticeable gap between one edge of the anchor shroud and the base plate 2123 of the anchor. Such deflection may also take the form of stretching of the coil spring at least generally along its long axis, with commensurate development of a gap between all edges of the shroud and the base plate of the anchor. As evident from the idealized representation of FIG. 7, in some instances both of these may occur.

Any suitable sensor 5000, operating by any desired mechanism and placed at any suitable location, may be used to monitor a horizontal fall-protection safety system (horizontal lifeline) e.g. of the general type represented in FIGS. 4-7. In some embodiments, such a sensor 5000 may rely on a sensing element 5001 in the form of a strain gauge, e.g. a bonded-foil strain gauge as described earlier herein. Such a strain gauge may be located at any suitable position. For example, it may be located at or near a neck 2126 of a deflectable member 2120 of an anchor 2020, since this location may be likely to experience the greatest strain when a force is applied to the anchor. Such a strain gauge, so placed, may be able to directly monitor the strain encountered at neck 2126 in order to detect a change in the physical state of deflectable member 2120.

In some embodiments a strain gauge may be located on elongate member (e.g. tensioned cable) 2001, e.g. at or near position 2032 as indicated in FIG. 4. In such cases a strain that is detected in cable 2001 may be correlated with the force expected to produce such a strain. The strain experienced by cable 2001 can thus be used to infer whether anchor 2020, e.g. a deflectable member thereof, has experienced a large enough force to cause a change in the physical state of the anchor. It will be appreciated that permanent deflection (e.g. stretching) of cable 2001 may not necessarily occur even in the event of a permanent deflection of anchor 2020. Accordingly, a strain gauge mounted on cable 2001 is an example of an arrangement in which a sensing element may need to be operated at least quasi-continuously or continuously in order to ensure that, for example, a strain event of large magnitude but short duration will be detected and datalogged. However, as discussed in detail below, in other arrangements (e.g. not involving monitoring of the strain in a tensioned cable) it may not be necessary for a sensing element to be operated even quasi-continuously, since in many such arrangements it may be possible to detect the consequences of an event (e.g. permanent deformation of a component of an anchor) after the fact.

In various embodiments, a sensing element 5001 of a sensor 5000 may take the form of an image acquisition device such as a camera. In some embodiments such a sensing element may be configured to monitor the state of an anchor 2020 or a component thereof. For example a camera may be able to monitor any displacement and/or change in shape of anchor 2020, of a shroud 2122 thereof, of a coil spring 2121 thereof, or of a deflectable member 2120 thereof. In some embodiments a camera may merely need detect any physical movement of anchor 2020 as a whole (e.g., a change into a configuration resembling that shown in FIG. 7). However, in some embodiments a camera may be configured to monitor a change in a specific component of an anchor, e.g. a change in the orientation of a deflectable member 2120, a change in the spacing between coils of a coil spring, and so on. To facilitate such monitoring, in some embodiments at least a portion of a shroud 2122 may be e.g. transparent.

In various embodiments, a sensing element 5001 of this or any other suitable type may be positioned on an anchor 2020, on a baseplate 2123, on a roof or other surface 2070 and so on, as long as the desired component can be monitored. In some embodiments, optical monitoring may be enhanced by positioning an optical sensing element (e.g. a camera) at right angles to any expected displacement of the anchor, e.g. at position 2031 of baseplate 2123, or at position 2033 on a rooftop 2070, as indicated in FIG. 4.

Any image-acquisition sensing element 5001 such as a camera may be configured to take single images, whether upon instruction from base unit 6000, or on an intermittent schedule. In other words, such a sensing element may be configured to detect permanent deformation after a strain/deformation event has happened. Such an arrangement may be contrasted e.g. with the use of a strain gauge positioned e.g. on the cable of the safety system that may need to be operated at least quasi-continuously in order that a strain/deformation event can be detected as it happens. In some embodiments a camera may be configured to provide a continuous video stream, again whether upon instruction, on a schedule, or constantly. While a primary purpose of such a camera may be the monitoring of a deflectable component as discussed herein, a sensing element of this type can also be used to monitor the overall state of an anchor and an elongated member connected thereto, a structure to which the anchor is attached, and so on. For example, such a camera may be able to ascertain whether an anchor or other component of a safety system appears to have sustained damage e.g. from some object (e.g. construction debris) falling onto the safety system. In some embodiments such a camera may be movable, e.g. orientable, so that the camera can examine various items as desired. Of course, multiple cameras may be used if desired.

Not every horizontal fall-protection safety system will necessarily comprise a deflectable component in the form of a pivotally-deflectable member of an anchor as in the exemplary arrangement described above. Rather, some horizontal safety systems may comprise an anchor that is hard-mounted to a roof, wall or other structure (i.e. without the anchor comprising any component that is purposefully designed to be deflectable). Some such systems may comprise one or more deflectable members in the form of an energy absorber that is mounted in-line with an elongate member (e.g. tensioned cable) of the safety system, in generally similar manner to the in-line energy absorbers discussed later herein with regard to horizontal fall-protection safety systems.

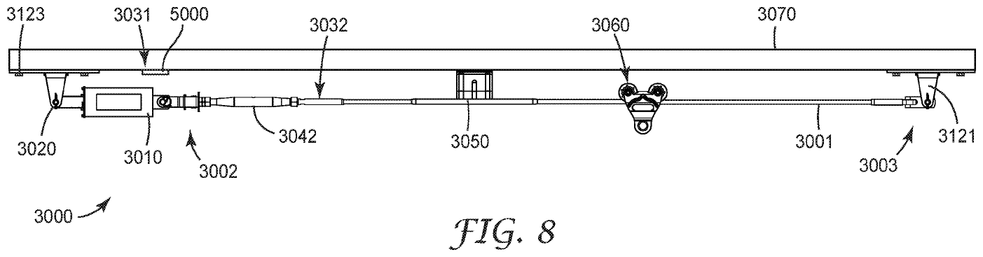

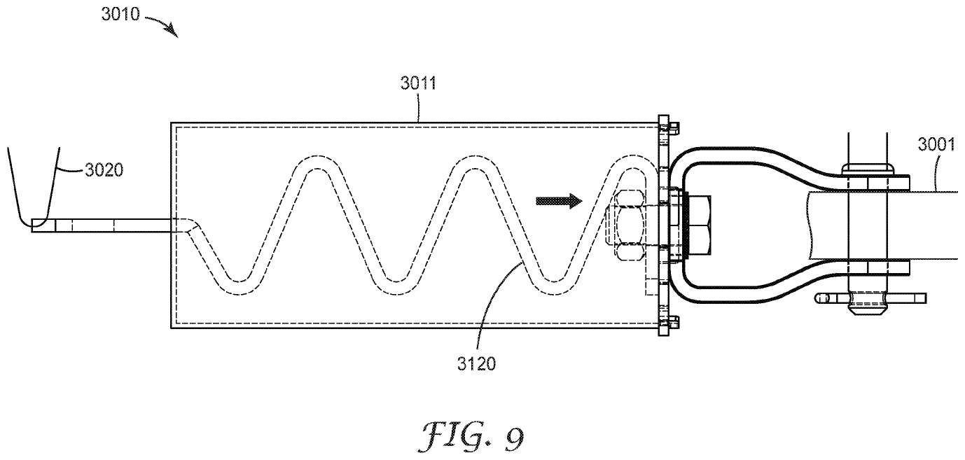

A horizontal fall-protection safety system 3000 of this general type is depicted in exemplary representation in the top (overhead) view of FIG. 8. Safety system 3000 comprises an elongate member (in this embodiment, a tensioned cable, made of e.g. metal such as galvanized steel or stainless steel) 3001, one end 3002 of which is connected to a first anchor 3020 and a second end 3003 of which is connected to a second anchor 3021 (in many instances anchors 3020 and 3021 may be identical). In the event that system 3000 is relatively long, one or more intermediate anchors 3050 may be present as in FIG. 8. Any such anchor, regardless of the exact design, is a component that is permanently attached (directly or indirectly) to a particular location of a rooftop, wall or other structure for the duration of the use of the safety system and to which an elongate member (e.g. a tensioned cable) of the horizontal safety system is connected or attached. In some embodiments, such an anchor may be attached to a baseplate that is attached to a wall, rooftop, or other suitable structure, e.g. in the manner of anchor 3020 and baseplate 3123 as shown in FIG. 8. All such anchors may comprise a connector (of any suitable type, and optionally comprising multiple components) that facilitates the connection of cable 3001 to anchor 3020. In many embodiments, a horizontal safety system 3000 may comprise a tensioner 3042 to enable cable 3001 to be tensioned appropriately. A user of safety system 3000 may wear a harness to which is attached one end of a tether or lanyard, the other end of which is attached to a traveler 3060 that is able to move (e.g. slide) along elongate member (e.g., cable) 3001, so that the person can move along the elongate length of member 3001 as desired. The traveler and/or a tether that connects the user's harness to the traveler may comprise a shock absorber.

In other words, a horizontal fall-protection system 3000 as shown in FIG. 8 is generally similar in structure and function to horizontal fall-protection system 2000 shown in FIG. 4. The main difference is that in system 3000 of FIG. 8, anchors 3020 and 3021 (and intermediate anchor 3050) are not configured to be deflectable in the manner of anchors 2020 of system 2000. Rather, in system 3000 an energy absorber 3010 is mounted in-line with the elongate member (e.g. tensioned cable) 3001 of the safety system. As shown in exemplary manner in FIG. 9, in some embodiments an in-line energy absorber 3010 can rely on a deflectable member 3120, e.g. at least partially contained in a shell or casing 3011. Deflectable member 3120 may be able to undergo a number of events such as e.g. worker fall-arrests below a certain force threshold, as well as momentary tugs and the like as may occur during normal work operations, without being affected (e.g. undergoing permanent deformation) to the point that member 3120 and/or energy absorber 2020 as a whole necessarily need replacing. Such events will not result in a change in a physical state of a component of the safety system that is reported according to the systems and methods disclosed herein.

However, sufficient force transmitted from cable 3001 to deflectable member 3120 can cause member 3120 to extensibly, e.g. permanently, deflect (e.g. to partially unfold or stretch from its initial “folded” configuration to a less folded configuration). A suitable sensing element (e.g. a camera) 5000 can be positioned (e.g. at location 3031 on structure 3070 as indicated in FIG. 8) to monitor any changes in energy absorber 3010 and/or deflectable member 3120 thereof. For example, such deflection might cause an end portion of member 3120 to extend outward beyond the end of shell 3011, might cause shell 3011 to deform or rupture, and so on. Of course, in some embodiments a strain gauge may be positioned on deflectable member 3120 itself, to directly monitor the strain experienced by member 3120, in similar manner to the uses of a strain gauge described earlier herein.

An in-line energy absorber need not be of the particular exemplary design shown in FIG. 9. For example, in some embodiments an inline energy absorber may rely on arrangement of one or more strips (made of, e.g., metal) that can absorb energy by way of, for example, at least one strip at least partially straightening out from a rolled-up configuration and/or by way of two strips at least partially tearing away from each other. Any such motion or combination or variation thereof will be understood to be encompassed by terms such as deflect, deflection, and deflecting as used herein. Energy absorbers of this general type are described e.g. in U.S. Pat. No. 6,279,680, which is incorporated by reference in its entirety herein. Suitable energy absorbers also include those of the general type described in Technical Data Sheet 7241422 available from 3M Fall Protection, Red Wing Minn.

Thus in summary, any horizontal fall-protection safety system of any suitable type may be monitored by any suitable sensor, relying on any suitable sensing element operating according to any desired mechanism. In addition to the specific exemplary sensing elements and operating mechanisms discussed above, the previously-presented general categories, specific types, and operation mechanisms of sensing elements, may be chosen for use with a horizontal safety system.

In some embodiments, a permanent fall-protection safety system with which the monitoring systems and methods disclosed herein may be used, may be an “inclined” system. An inclined fall-protection safety system is defined herein as a system that allows a person to travel along a path that is oriented between 15 and 75 degrees away from horizontal (and, likewise, between 15 and 75 degrees away from vertical). In various embodiments an elongate member (e.g. a rail or tensioned cable) of such a safety system may be oriented within a range of 15-30, 30-45, 45-60, or 60-75, degrees from horizontal. Any such inclined system may comprise any or the previously-described components, e.g. one or more anchors, deflectable components, travelers, and so on.

The herein-described monitoring systems and methods will be used in accordance with all instructions provided by the supplier of the monitoring system. The use of monitoring systems and methods as disclosed herein will be an adjunct to customary procedures (e.g. maintenance, inspection, safety precautions, and so on) that are followed in the use of a fall-protection safety system with which these monitoring systems and methods may be used. The use of the monitoring systems and methods described herein will not relieve a user of a fall-protection safety system of the requirement to follow the instructions and guidelines provided by the supplier of the fall-protection safety system and to comply with all applicable laws, rules, and standards.

### List of Exemplary Embodiments

Embodiment 1 is a method of monitoring and reporting the condition of a permanent fall-protection safety system, the method comprising: using a stationary, permanent, self-powered sensor to obtain data corresponding to a physical state of at least one component of the safety system, to which component a permanent, elongate member of the safety system is connected, wherein the at least one component and the sensor are at a remote location and/or at an elevated height, relative to a base unit; wirelessly transmitting the data to the base unit; processing the data to reach an indication of a change in a physical state of the at least one component of the safety system, and, reporting the condition of the safety system based on the indication of the change in the physical state of the at least one component of the safety system.

Embodiment 2 is the method of embodiment 1 wherein the permanent, elongate member of the safety system is a tensioned cable.

Embodiment 3 is the method of embodiment 2 wherein the safety system is a vertical fall-protection safety system and wherein the at least one component of the safety system is a top bracket of the safety system, to which top bracket the tensioned cable is connected.

Embodiment 4 is the method of embodiment 3 wherein the at least one component of the safety system is a pivotally deflectable plate of the top bracket of the safety system.

Embodiment 5 is the method of embodiment 4 wherein the data corresponding to a physical state of at least one component of the safety system comprises data indicative of a gap width between a rearward abutment surface of the pivotally deflectable plate of the top bracket and a forward abutment surface of an abutment plate of the top bracket.

Embodiment 6 is the method of embodiment 5 wherein the data indicative of the gap width is obtained by optical monitoring of the gap.

Embodiment 7 is the method of embodiment 3 wherein the stationary, permanent, self-powered sensor comprises at least one strain gauge that is mounted on the tensioned cable of the safety system in a position proximate the top bracket or is mounted on a neck of a pivotally deflectable plate of the top bracket.

Embodiment 8 is the method of embodiment 2 wherein the safety system is a horizontal fall-protection safety system and wherein the at least one component of the safety system comprises an anchor of the horizontal fall-protection safety system, to which anchor the tensioned cable of the safety system is connected.

Embodiment 9 is the method of embodiment 8 wherein the at least one component of the safety system comprises a deflectable component of the anchor and wherein the data corresponding to a physical state of at least one component of the safety system comprises data indicative of a deflection of the deflectable component.

Embodiment 10 is the method of any of embodiments 8-9 wherein the data corresponding to a physical state of at least one component of the safety system comprises data indicative of a displacement, a change in position, and/or a change in shape, of a shroud of the anchor.

Embodiment 11 is the method of embodiment 2 wherein the safety system is a horizontal fall-protection safety system and wherein the at least one component of the safety system comprises an energy absorber that is in-line with the tensioned cable of the safety system.

Embodiment 12 is the method of embodiment 11 wherein the at least one component of the safety system comprises a deflectable component of the energy absorber and wherein the data corresponding to a physical state of at least one component of the safety system comprises data indicative of a deflection of the deflectable component of the energy absorber.

Embodiment 13 is the method of any of embodiments 1-12 wherein the stationary, permanent, self-powered sensor comprises a sensing element that obtains the data corresponding to a physical state of at least one component of the safety system, and further comprises a wireless radio transmitter and a battery.

Embodiment 14 is the method of embodiment 13 wherein the sensor further comprises a wireless radio receiver and wherein the stationary, permanent, self-powered sensor remains in a dormant state until the sensor receives a wireless radio signal from the base unit that instructs the sensor to obtain data corresponding to the physical state of at least one component of the safety system to which the permanent lifeline is connected.

Embodiment 15 is the method of embodiment 13 wherein the stationary, permanent, self-powered sensor obtains data corresponding to the physical state of at least one component of the safety system to which the permanent lifeline is connected, periodically according to a pre-determined schedule comprising a data-taking frequency of no greater than once per minute.

Embodiment 16 is the method of embodiment 13 wherein the stationary, permanent, self-powered sensor obtains data corresponding to the physical state of at least one component of the safety system to which the permanent lifeline is connected, at least quasi-continuously at a data-taking frequency of at least once every 0.2 seconds.

Embodiment 17 is the method of any of embodiments 13-16 wherein the sensor further comprises a data-storage unit and wherein the data that is obtained by the sensing element of the sensor is stored in the data-storage unit of the sensor until at least such time as the data is wirelessly transmitted to the base unit.

Embodiment 18 is the method of embodiment 17 wherein the data is wirelessly transmitted to the base unit upon the sensor receiving a wireless radio signal from the base unit instructing the sensor to wirelessly transmit the data to the base unit.

Embodiment 19 is the method of embodiment 17 wherein the data is wirelessly transmitted by the sensor on a specified periodic schedule.

Embodiment 20 is the method of any of embodiments 13-19 wherein the sensor wirelessly transmits the data via short-range wireless radio transmission to a portable base unit that is located within 200 meters of the sensor.

Embodiment 21 is the method of any of embodiments 13-19 wherein the sensor transmits the data to a fixed, non-portable base unit that is more than 200 meters away from the sensor, by a route at least a portion of which is over a cellular network.

Embodiment 22 is the method of embodiment 21 wherein the base unit is configured to receive data corresponding to a physical state of at least one component of a safety system to which a permanent lifeline is connected, from a plurality of sensors of different safety systems.

Embodiment 23 is the method of embodiment 22 wherein a first stationary, permanent, self-powered sensor of a first safety system, is configured to transmit data obtained by the first sensor and to include information identifying the data as originating from the first sensor; and, wherein the first sensor is additionally configured to wirelessly receive data from a second stationary, permanent, self-powered sensor of a second safety system and to re-transmit the data from the second sensor along with information identifying the data as originating from the second sensor.

Embodiment 24 is the method of any of embodiments 1-23 wherein the permanent, elongate member of the safety system is made of metal.

Embodiment 25 is a monitored, permanent fall-protection system comprising: a fall-protection safety system comprising a permanent, elongate member that is fixed in place on a structure and that is configured to allow a person to move along at least a portion of the elongate length of the member while remaining connected to the member; and, at least one stationary, permanent, self-powered sensor that is configured to obtain, and to wirelessly transmit to a base unit, data corresponding to a physical state of at least one component of the safety system, to which component the permanent, elongate member of the safety system is connected; wherein the base unit is configured to report a condition of the safety system based on an indication of a change in the physical state of the at least one component of the safety system as indicated by the data wirelessly transmitted by the sensor, and wherein the at least one component and the sensor are at a remote location and/or at an elevated height, relative to the base unit.

Embodiment 26 is the system of embodiment 25 wherein the system comprises any of the components, features and/or functionalities of any of embodiments 1-24.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). To the extent that there is any conflict or discrepancy between this specification as written and the disclosure in any document that is incorporated by reference herein, this specification as written will control.

What is claimed is:

1. A method of monitoring and reporting the condition of a permanent fall-protection safety system, the method comprising:
using a stationary, permanent, self-powered sensor to obtain data corresponding to a physical state of at least one component of the safety system, to which component a permanent, elongate member of the safety system is connected, wherein the at least one component and the sensor are at a remote location and/or at an elevated height, relative to a base unit;
wirelessly transmitting the data to the base unit;
processing the data to reach an indication of a change in a physical state of the at least one component of the safety system,
and,
reporting the condition of the safety system based on the indication of the change in the physical state of the at least one component of the safety system.

2. The method of claim 1 wherein the permanent, elongate member of the safety system is a tensioned cable.

3. The method of claim 2 wherein the safety system is a vertical fall-protection safety system and wherein the at least one component of the safety system is a top bracket of the safety system, to which top bracket the tensioned cable is connected.

4. The method of claim 3 wherein the at least one component of the safety system is a pivotally deflectable plate of the top bracket of the safety system.

5. The method of claim 4 wherein the data corresponding to a physical state of at least one component of the safety system comprises data indicative of a gap width between a rearward abutment surface of the pivotally deflectable plate of the top bracket and a forward abutment surface of an abutment plate of the top bracket.

6. The method of claim 5 wherein the data indicative of the gap width is obtained by optical monitoring of the gap.

7. The method of claim 3 wherein the stationary, permanent, self-powered sensor comprises at least one strain gauge that is mounted on the tensioned cable of the safety system in a position proximate the top bracket or is mounted on a neck of a pivotally deflectable plate of the top bracket.

8. The method of claim 2 wherein the safety system is a horizontal fall-protection safety system and wherein the at least one component of the safety system comprises an anchor of the horizontal fall-protection safety system, to which anchor the tensioned cable of the safety system is connected.

9. The method of claim 8 wherein the at least one component of the safety system comprises a deflectable component of the anchor and wherein the data corresponding to a physical state of at least one component of the safety system comprises data indicative of a deflection of the deflectable component.

10. The method of claim 8 wherein the data corresponding to a physical state of at least one component of the safety system comprises data indicative of a displacement, a change in position, and/or a change in shape, of a shroud of the anchor.

11. The method of claim 2 wherein the safety system is a horizontal fall-protection safety system and wherein the at least one component of the safety system comprises an energy absorber that is in-line with the tensioned cable of the safety system.

12. The method of claim 11 wherein the at least one component of the safety system comprises a deflectable component of the energy absorber and wherein the data corresponding to a physical state of at least one component of the safety system comprises data indicative of a deflection of the deflectable component of the energy absorber.

13. The method of claim 1 wherein the stationary, permanent, self-powered sensor comprises a sensing element that obtains the data corresponding to a physical state of at least one component of the safety system, and further comprises a wireless radio transmitter and a battery.

14. The method of claim 13 wherein the sensor further comprises a wireless radio receiver and wherein the stationary, permanent, self-powered sensor remains in a dormant state until the sensor receives a wireless radio signal from the base unit that instructs the sensor to obtain data corresponding to the physical state of at least one component of the safety system to which the permanent lifeline is connected.

15. The method of claim 13 wherein the stationary, permanent, self-powered sensor obtains data corresponding to the physical state of at least one component of the safety system to which the permanent lifeline is connected, periodically according to a pre-determined schedule comprising a data-taking frequency of no greater than once per minute.

16. The method of claim 13 wherein the stationary, permanent, self-powered sensor obtains data corresponding to the physical state of at least one component of the safety system to which the permanent lifeline is connected, at least quasi-continuously at a data-taking frequency of at least once every 0.2 seconds.

17. The method of claim 13 wherein the sensor further comprises a data-storage unit and wherein the data that is obtained by the sensing element of the sensor is stored in the data-storage unit of the sensor until at least such time as the data is wirelessly transmitted to the base unit.

18. The method of claim 17 wherein the data is wirelessly transmitted to the base unit upon the sensor receiving a wireless radio signal from the base unit instructing the sensor to wirelessly transmit the data to the base unit.

19. The method of claim 17 wherein the data is wirelessly transmitted by the sensor on a specified periodic schedule.

20. The method of claim 13 wherein the sensor wirelessly transmits the data via short-range wireless radio transmission to a portable base unit that is located within 200 meters of the sensor.

21. The method of claim 13 wherein the sensor transmits the data to a fixed, non-portable base unit that is more than 200 meters away from the sensor, by a route at least a portion of which is over a cellular network.

22. The method of claim 21 wherein the base unit is configured to receive data corresponding to a physical state of at least one component of a safety system to which a permanent lifeline is connected, from a plurality of sensors of different safety systems.

23. The method of claim 11 wherein a first stationary, permanent, self-powered sensor of a first safety system, is configured to transmit data obtained by the first sensor and to include information identifying the data as originating from the first sensor; and, wherein the first sensor is additionally configured to wirelessly receive data from a second stationary, permanent, self-powered sensor of a second safety system and to re-transmit the data from the second sensor along with information identifying the data as originating from the second sensor.

24. A monitored, permanent fall-protection system comprising:
a fall-protection safety system comprising a permanent, elongate member that is fixed in place on a structure and that is configured to allow a person to move along at least a portion of the elongate length of the member while remaining connected to the member;
and,
a stationary, permanent, self-powered sensor that is configured to obtain, and to wirelessly transmit to a base unit, data corresponding to a physical state of at least one component of the safety system, to which component the permanent, elongate member of the safety system is connected;
wherein the base unit is configured to report a condition of the safety system based on an indication of a change in the physical state of the at least one component of the safety system as indicated by the data wirelessly transmitted by the sensor,
and wherein the at least one component and the sensor are at a remote location and/or at an elevated height, relative to the base unit.
